(19) United States
(12) Patent Application Publication
(10) Pub. No.: US 2018/0087516 A1
(43) Pub. Date: Mar. 29, 2018

(54) TURBOMACHINE WITH ACTIVE MAGNETIC BEARINGS

(71) Applicant: General Electric Company, Schenectady, NY (US)

(72) Inventors: Mohamed Osama, Garching (DE); Rosa Castane Selga, Eching (DE); Thomas Johannes Frey, Regensburg (DE)

(21) Appl. No.: 15/277,255

(22) Filed: Sep. 27, 2016

(51) Int. Cl. F04D 29/048; F04D 3/00; F04D 13/08; F04D 29/52; F04D 29/18; F04D 31/00; H02K 7/09; F16C 32/04

(52) U.S. Cl. CPC F04D 29/048; F04D 3/00; F04D 13/08; F04D 29/528; F16C 2360/44; F04D 31/00; H02K 7/09; F16C 32/0485; F16C 32/0446; F04D 29/181

(57) ABSTRACT

An active magnetic bearing system includes a radial actuator and an axial actuator. The radial actuator includes a radial stator coupled to a stationary component, and a radial rotor coupled to a rotatable impeller. The radial rotor extends circumferentially with respect to the radial stator and is configured to rotate about the radial stator. The axial actuator has first and second rotor rings and first and second stators. The first rotor ring is attached to a first axial end of the impeller, and the second rotor ring is attached to a second axial end of the impeller. The first and second stators are coupled to the shaft adjacent the first and second rotor rings, respectively. The radial actuator is positioned axially between the first and second rotor rings.

### BACKGROUND

The subject matter described herein relates generally to turbomachines, and more specifically, to axial modular multistage pumps for pumping a multiphase fluid, for example, mixed oil and gas.

Subsea gas and oil pumps are used in offshore installations to extract hydrocarbons from subsea oilfields. Known subsea, downhole, and electrical submersible pumps are driven by electric motors which are arranged coaxial with the turbomachine stages. A fluid flow processed by the subsea pumps usually contains a mixture of gaseous and liquid hydrocarbons with a variable gas volume fraction or liquid volume fraction. Typically, subsea pumps use mechanical bearings, such as ball bearings or roller bearings. Such known mechanical bearings, however, may exhibit limited endurance in use in subsea pumps, and require an auxiliary lubricating system. Auxiliary lubrication systems increase the cost of manufacturing such known pump systems, and also increase the complexity, physical size, and weight of such pump systems.

At least some known subsea pumps use mechanical bearings lubricated and cooled by the process fluid. The process fluid, however, may contain small, hard particulate that can damage the bearings, therefore shorting the useful life. In addition, known mechanical bearings are less efficient due to friction forces during bearing use.

### BRIEF DESCRIPTION

In one aspect, an active magnetic bearing system is provided. The active magnetic bearing system includes a radial actuator including a radial stator coupled to a stationary component, and a radial rotor coupled to a rotatable impeller. The radial rotor extends circumferentially with respect to the radial stator and is configured to rotate about the radial stator. The active magnetic bearing system also includes an axial actuator including a first rotor ring, a second rotor ring, a first stator, and a second stator. The first rotor ring is coupled to a first axial end of the rotatable impeller. The second rotor ring is coupled to a second axial end of the rotatable impeller opposite the first axial end. The first stator is coupled to the stationary component adjacent the first rotor ring in a face-to-face orientation. Furthermore, the second stator is coupled to the stationary component adjacent the second rotor ring in a face-to-face orientation. The radial actuator is positioned axially between the first rotor ring and the second rotor ring.

In another aspect, a turbomachine is provided. The turbomachine includes a casing and a stationary shaft having a longitudinal center axis. The turbomachine also includes a first pump stage positioned in the casing. The first pump stage includes a first rotatable impeller configured to rotate about the longitudinal center axis. The first rotatable impeller includes a first blade having a first root. The turbomachine includes a second pump stage positioned in the casing. The second pump stage includes a second rotatable impeller configured to rotate about the longitudinal center axis. The second rotatable impeller includes a second blade having a second root. Moreover, the turbomachine includes an active magnetic bearing system having an axial actuator including a first rotor ring, a second rotor ring, a first stator, and a second stator. The first rotor ring is coupled to a first end of at least one of the first root and the second root. The second rotor ring is coupled to a second end opposite the first end of the at least one of the first root and the second root. The first stator is coupled to the stationary shaft adjacent the first rotor ring in a face-to-face orientation. Furthermore, the second stator is coupled to the stationary shaft adjacent the second rotor ring in a face-to-face orientation. The first rotatable impeller is configured to rotate independently of the second rotatable impeller.

In yet another aspect, a method of assembling a turbomachine is provided. The method includes coupling a stationary shaft within a casing. The stationary shaft has a longitudinal center axis. The method also includes rotatably coupling a first impeller to the stationary shaft. The first impeller is configured to rotate about the longitudinal center axis. The first rotatable impeller includes a first blade having a first root. Moreover, the method includes rotatably coupling a second impeller to the stationary shaft adjacent the first impeller. The second impeller is configured to rotate about the longitudinal center axis. The second impeller includes a second blade having a second root. In addition, the method includes coupling an axial actuator to at least one of the first impeller and the second impeller. The axial actuator includes a first rotor ring, a second rotor ring, a first stator, and a second stator. Coupling the axial actuator includes coupling the first rotor ring to a first end of at least one of the first root and the second root. Moreover, coupling the axial actuator includes coupling the second rotor ring to a second end opposite the first end of the at least one of the first root and the second root. In addition, coupling the axial actuator includes coupling the first stator to the stationary shaft adjacent the first rotor ring in a face-to-face orientation. Furthermore, coupling the axial actuator also includes coupling the second stator to the stationary shaft adjacent the second rotor ring in a face-to-face orientation. The first rotatable impeller is configured to rotate independently of the second rotatable impeller.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic cross-section of an exemplary axial modular contra-rotating pump including an active magnetic bearing (AMB) system;

FIG. 2 is an enlargement of a portion of the pump shown in FIG. 1;

FIG. 3 is a schematic cross-section of a portion of one embodiment of a pump stage of the pump shown in FIG. 1;

FIG. 4 is a schematic cross-section of a portion of an alternative embodiment of a pump stage of the pump shown in FIG. 1;

FIG. 5 is a block diagram of a controller for use with the AMB system 102 shown in FIG. 1;

FIG. 6 is an enlargement of a portion of the pump shown in FIG. 1, showing an alternative AMB system; and

FIG. 7 is an enlargement of a portion of the pump shown in FIG. 1, showing another alternative AMB system.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the terms “processor” and “computer” and related terms, e.g., “processing device,” “computing device,” and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

The systems described herein facilitate independently controlling individual bearings in an axial modular multistage pump using a novel active magnetic bearing (AMB) system. Specifically, example embodiments describe an axial modular contra-rotating pump. Individual stages of the pump include a radial AMB having an outer rotor coupled to an impeller of the pump, and an inner stator coupled to a stationary shaft of the pump. In addition, the impeller includes a unique AMB thrust bearing having two discrete rotor rings and stators. Each of the rotor rings is coupled to an opposing end of the impeller. A respective stator is coupled to a portion of the stationary shaft of the pump, opposite a respective rotor ring. A controller of the AMB system senses changes in the impellers position and the electrical currents in the individual AMBs to determine the rotor dynamics of the individual stages of the pump. The stiffness and damping characteristics for each stage of the pump is controlled in a linear or non-linear manner to facilitate counteracting the rotor dynamics to facilitate reducing vibrations and other gyroscopic motion.

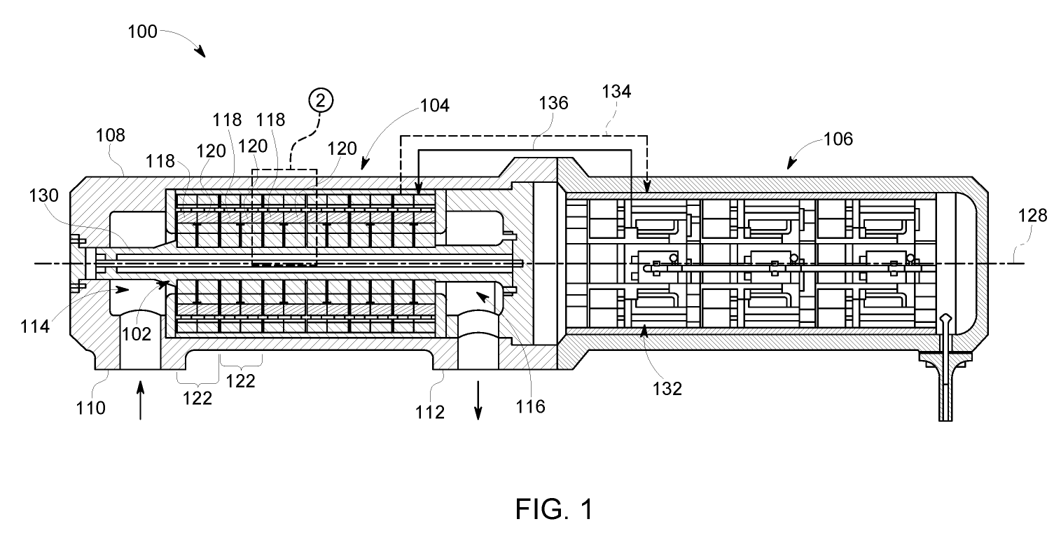

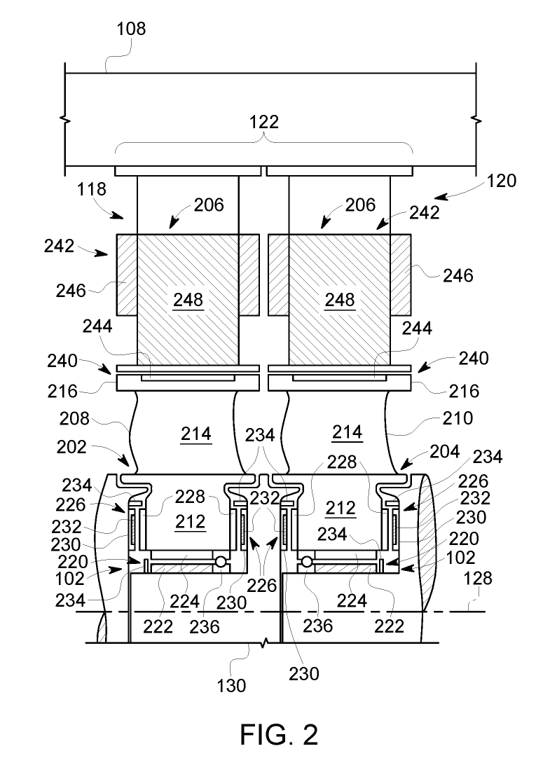

FIG. 1 is a schematic cross-section of an exemplary turbomachine or pump 100 including an active magnetic bearing (AMB) system 102. FIG. 2 is an enlargement of a portion of pump 100 (shown in FIG. 1). In the exemplary embodiment, pump 100 is an axial modular contra-rotating pump (MCP) equipped with AMB system 102. Alternatively, pump 100 can be any type of axial turbomachine, for example, and without limitation, a multiphase pump suitable for boosting the pressure of a fluid, such as a multiphase fluid including liquid containing a percentage of a compressible gas. In addition, while described herein as a contra-rotating pump, stages of pump 100 can be contra-rotating or co-rotating.

In the exemplary embodiment, pump 100 includes a pump section 104 and a controller section 106. Pump section 104 includes a casing 108 having an inlet manifold 110 and an outlet manifold 112. Casing 108 is one of a vertically-split or a horizontally-split type casing. For example, and without limitation, in one embodiment, vertically-split type casing 108 includes a central barrel portion (not shown) and two end portions (not shown), each sealingly coupled to opposite ends of the central barrel portion. In another embodiment, horizontally-split type casing 108 is split axially and includes an upper half portion (not shown) and a lower half portion (not shown), sealingly coupled to each other.

Pump 100 also includes an inlet plenum 114 in flow communication with inlet manifold 110, and an outlet plenum 116 in flow communication with outlet manifold 112. The multiphase fluid flows into pump 100 through inlet manifold 110 where it passes to inlet plenum 114. The multiphase fluid then flows generally axially through pump 100 towards outlet plenum 116, across two or more pump stages, for example, pump stages 118 and 120. The multiphase fluid then flows out of the pump 100, passing from outlet plenum 116 through outlet manifold 112.

In the exemplary embodiment, pump stages 118, 120 are configured as a pair 122, arranged in sequence in the flow direction of the multiphase fluid. As shown in FIG. 1, pump 100 includes a plurality of pairs 122 of pump stages 118, 120. With respect to each respective pair 122, pump stage 118 includes an impeller 202 and pump stage 120 includes an impeller 204. Impellers 202 and 204 are rotated about a longitudinal center axis 128 of pump 100, driven by a respective embedded electric motor 206 in each pump stage 118, 120. Impellers 202 and 204 of each pair 122 rotate in opposite directions, i.e., they are counter-rotating. For example, in one embodiment, impeller 202 of pump stage 118 rotates in a clockwise direction and impeller 204 of pump stage 120 rotates in a counter-clockwise direction. It is noted that each pair 122 of pump stages 118, 120 are arranged in pump 100 in sequence, oriented substantially the same direction, such that the most upstream pump stage impeller, impeller 202 of pump stage 118 for example, rotates in the same direction. Thus, within pump 100, each subsequent pump stage is rotating in the opposite direction of the previous adjacent pump stage.

While described in the exemplary embodiment as including pump stages 118, 120 configured as a pair 122 rotating in opposite directions, it is noted that in alternative embodiments, the pump stages of pump 100 can be rotated in the same direction and/or configured in groups including more than two pump stages. In addition, embedded electric motor 206 can be configured to drive more than one pump stage.

Impeller 202 includes one or more impeller blades 208, and impeller 204 includes one or more complementary impeller blades 210. Each of impeller blades 208 and 210 include a root 212, an airfoil 214, and a tip shroud 216. In some embodiments, root 212 of impeller blades 208 and 210 is formed as a monolithic ring. In alternative embodiments, roots 212 of one or more impeller blades 208 and 210 are coupled to each other or to a hub (not shown) to form impeller 202 or impeller 204. Correspondingly, in some embodiments, tip shroud 216 is formed as a monolithic ring. Alternatively, tip shrouds 216 are coupled to each other to form impeller 202 or impeller 204.

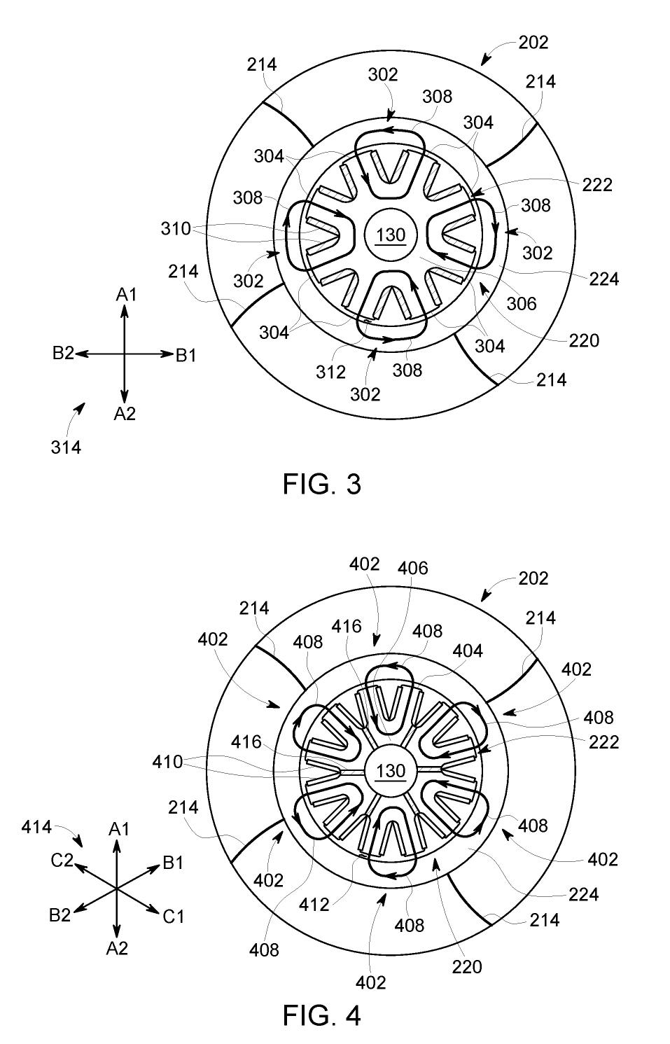

In the exemplary embodiment each impeller 202, 204 is supported by AMB system 102 coupled to a stationary shaft 130, i.e., a non-rotating shaft. AMB system 102 includes at least one active magnetic bearing 220 and 226. In the exemplary embodiment, AMB system 102 includes a first radial active magnetic bearing 220, or actuator, coupled between each of impellers 202, 204, and stationary shaft 130. Alternatively, AMB system 102 can include any number of radial actuators that enable impellers 202, 204 to function as described herein. Radial actuators 220 generate a magnetic field that controls the position of impellers 202, 204 in a radial direction. As used herein, the term “radial” refers to a direction perpendicular to longitudinal center axis 128 of pump 100. In the exemplary embodiment, actuator 220 is configured for supporting impellers 202, 204 in a non-contact, levitating state with respect to stationary shaft 130. Unlike conventional radial magnetic bearings, actuator 220 includes an inner stator 222 coupled to stationary shaft 130. Inner stator 222 includes a lamination stack (not shown) to carry a magnetic flux (shown in FIG. 3) and windings (shown in FIG. 3) to carry an electric current to generate the magnetic flux. Actuator 220 also includes an outer rotor 224 lamination stack coupled to an inner diameter of impellers 202, 204. Outer rotor 224 extends circumferentially around inner stator 222 and is configured to rotate about inner stator 222. In an alternative embodiment, actuator 220 is of a hybrid configuration that includes a permanent magnet and electromagnet combination. In another alternative embodiment, actuator 220 can be of a conventional arrangement and include an inner rotor and an outer stator, where actuator 220 is coupled between each of impellers 202, 204, and the respective embedded electric motor 206 in each pump stage 118, 120.

In addition, in the exemplary embodiment, AMB system 102 includes a first axial active magnetic bearing 226, or actuator, coupled between each of impellers 202, 204, and stationary shaft 130. Alternatively, AMB system 102 can include any number of axial actuators that enable impellers 202, 204 to function as described herein. Axial actuators 226 generate a magnetic field that controls an axial position of impellers 202, 204. As used herein, the term “axial” refers to a direction parallel to longitudinal center axis 128 of pump 100. Actuator 226 is configured for supporting impellers 202, 204 in a non-contact manner with respect to stationary shaft 130. Unlike conventional magnetic thrust bearings, actuator 226 includes two non-laminated rotor rings 228 coupled to opposite ends of impellers 202, 204. In particular, rotor rings 228 are coupled to root 212 of respective impeller blades 208 and 210. Actuator 226 also includes two stators 230 coupled to stationary shaft 130, one stator 230 positioned on each end of root 212 and oriented face-to-face, defining an air-gap therebetween. Stator 230 includes one of a laminated stack or a non-laminated stack configured to carry magnetic flux, and windings 232 to carry an electric current to generate the magnetic flux. In the exemplary embodiment, stator 230 has an axisymmetric C-core electromagnet topology, i.e., having an axisymmetric C-shaped core. In alternative embodiments, stator 230 has an axisymmetric E-core electromagnet topology, i.e., having an axisymmetric E-shaped core. An advantage of using the axisymmetric C-core is that actuator 226 requires half the number of armature-turns to achieve the same electromagnetic force as an axisymmetric E-core. An advantage of using the axisymmetric E-core is inherent flux path splitting, which facilitates decreasing a size of stator 230 and rotor rings 228.

AMB system 102 includes at least one position sensor 234 positioned adjacent to and integrated with each actuator 220, 226. In the exemplary embodiment, actuators 220, 226 and position sensors 234 form non-collocated sensor-actuator pairs. In alternative embodiments, position sensor 234 is integrally formed with actuators 220, 226 forming collocated sensor pairs. The term “non-collocated” as used herein refers to the actuator and its paired position sensor not being in the same axial plane, whereas “collocated” refers to the actuator and position sensor being located in the same axial plane. The term “adjacent” means near to in space or position, or next to, whether or not the two items are separated.

In the exemplary embodiment, position sensors 234 are configured to determine an air gap distance (not shown in FIGS. 1 and 2) between impellers 202, 204 and various positions around actuators 220, 226. In the exemplary embodiment, a total air gap distance is predetermined, thereby enabling the air gap distance for various locations around each of actuators 220, 226 to be calculated by subtracting the measured air gap distance from the total air gap distance. In alternative embodiments, AMB system 102 includes any number of position sensors 234 that enable AMB system 102 to function as described herein. For example, without limitation, in one embodiment, AMB system 102 includes a position sensor coupled adjacent each end of one of actuators 220. Appropriate position sensors 234 include, without limitation, commercially-available eddy-current position sensors, inductive sensors, optical sensors, and capacitive sensors.

Furthermore, in the exemplary embodiment, pump 100 further includes radial auxiliary bearings 236 used to prevent impellers 202, 204 from contacting stationary shaft 130 in the event of a total loss of power or large transient load. Auxiliary bearings 236 include, for example, and without limitation, ball bearings, roller bearings, journal bearings, or any other type of mechanical bearing that enables pump 100 to function as described herein. Auxiliary bearings 236 include a clearance between impellers 202, 204 or stationary shaft 130 and auxiliary bearings 236, such that the impellers 202, 204 or stationary shaft 130 do not contact auxiliary bearings 236 during normal operation of pump 100. Auxiliary bearings 236 are configured to receive impellers 202, 204 when actuators 220 are unable to support impellers 202, 204 and/or when actuators 220 are not powered. For example, and without limitation, impellers 202, 204 contact auxiliary bearings 236 when impellers 202, 204 experience loads approaching, and potentially exceeding, the capacity of actuators 220. In addition, auxiliary bearings 236 receive impellers 202, 204 during start-up and shut-down of pump 100.

In the exemplary embodiment, each pump stage 118, 120 include a respective embedded electric motor 206. Electric motors 206 include, for example, and without limitation, permanent magnet electric motors, switched or synchronous reluctance electric motors, variable reluctance electric motors, or any type of electric motor that enables pump 100 to function as described herein. In the exemplary embodiment, electric motor 206 is a permanent magnet (PM) motor and includes a rotor 240 and a stator 242. Rotor 240 rotates integrally with impellers 202, 204 and is formed, at least in part, integrally with shroud 216. Rotor 240 includes a plurality of permanent magnets 244 coupled to shroud 216. Stator 242 includes a plurality of coils 246 wound around a ferromagnetic core 248. In the exemplary embodiment, each electric motor 206 can be individually controlled, such that the rotation speed of each pump stage can be individually adjusted. For example, and without limitation, the rotation speed of each subsequent pump stage can be decreased and/or increased relative to a preceding pump stage.

FIG. 3 is a schematic cross-section of a portion of one embodiment of pump stage 118, 120 from the perspective of a plane perpendicular to the longitudinal center axis 128 of pump 100 (shown in FIG. 1). In the exemplary embodiment, radial actuator 220 includes four electromagnets 302 to control electromagnetic forces in two orthogonal directions (defining two respective radial control axes), as shown by the bearing axes diagram 314. Each electromagnet 302 is formed from two poles 304 of stator 222, such that stator 222, or more particularly, stator core or yoke 306 includes eight poles 304. In an alternative embodiment, each electromagnet 302 is formed from more than two poles 304 of stator 222, such that stator 222, or more particularly, stator core or yoke 306 includes, for example, and without limitation, twelve poles 304, sixteen poles 304, or any number of poles 304 to enable radial actuator 220 to function as described herein. In the exemplary embodiment, electromagnets 302 define bearing axes A1, B1, A2, and B2, with a 90° radial spacing between the bearing axes. Two electromagnets 302 positioned at 180° radial separation function jointly to generate a respective one of the control axes. Stator yoke 306 is fabricated from, for example, a ferromagnetic material configured to carry a magnetic flux 308. Stator yoke 306 is coupled to stationary shaft 130.

Outer rotor 224 is also fabricated from a ferromagnetic material configured to carry magnetic flux 308. Outer rotor 224 is coupled to an inner diameter of impellers 202, 204, for example, and thus integrally rotates with impellers 202, 204. A distance or air gap 312 is defined between stator 222 and outer rotor 224 when actuator 220 is active. In the exemplary embodiment, air gap 312 is in the range between, and inclusive of, about 0.010 inches (in.) (0.25 millimeters) and 0.080 in. (2.0 mm).

To generate magnetic flux 308, each pole 304 includes an electric coil 310 wound around the respective pole 304. Coils 310 of a pair of adjacent poles 304 are electrically coupled to each other, wound in opposite directions, and electrically coupled to an electrical power source to form electromagnet 302 and generate magnetic flux 308. Accordingly, in the exemplary embodiment, actuator 220 includes four electromagnets 302 having independent electrical currents. In the exemplary embodiment, stator 222 and outer rotor 224 are fabricated from laminations to facilitate reducing eddy currents from flowing in the ferromagnetic materials. Eddy currents, for example, hinder the rate of change of the magnetic flux 308, and hence deteriorate electromagnets 302 dynamic force performance.

FIG. 4 is a schematic cross-section of a portion of an alternative embodiment of pump stage 118, 120 from the perspective of a plane perpendicular to the longitudinal center axis 128 of pump 100 (shown in FIG. 1). In the exemplary embodiment, radial actuator 220 is a fault tolerant actuator and includes stator 222 coupled to stationary shaft 130 and rotor 224 coupled to an inner diameter of impellers 202, 204, for example, and thus integrally rotatable with impellers 202, 204. Stator 222 includes a stator core 46 having a plurality of stator poles 404, each having a coil or winding 410 wound thereon. Pairs of diametrically opposite stator poles 404 each define a respective radial control axis. Radial actuator 220 includes three radial control axes, as indicated by the bearing axes diagram 414. In particular, stator 222 has twelve electromagnetic stator poles 404 configured as six force-producing electromagnets 402 defining bearing axes A1, B1, C1, A2, B2, and C2, with a 60° radial spacing between the bearing axes. Two electromagnets 402 positioned at 180° radial separation function jointly to generate a respective one of the control axes.

Stator 222 is segmented circumferentially by positioning an axially extending nonmagnetic stator flux barrier 416 between adjacent pole pairs. Stator flux barriers 416 facilitate providing magnetic isolation for each pole pair and thus facilitate functioning force-actuating pole pairs to continue operating in such proximity to faulted magnetic poles. In the exemplary embodiment, any two of the three control axes are sufficient to maintain impeller 202, 204 suspension in bearing system 102. Accordingly, actuator 220 operation continues in the presence of faults, such as, for example, faulted magnetic poles, power electronic shorts, and phase power loss.

In operation, magnetic flux 408 generated by energizing each pole winding 410 circulates through stator poles 404 of each respective pole pair and through outer rotor 224 and stator core 406, crossing an air gap 412. In the exemplary embodiment, air gap 412 is in the range between, and inclusive of, about 0.010 in. (0.25 mm) and 0.080 in. (2.0 mm). Advantages of the three-axis magnetic bearing or actuator 220 of FIG. 4 include facilitating reducing or inhibiting bearing failure if one axis is inoperative.

With reference back to FIGS. 1 and 2, AMB system 102 further includes a controller 132 communicatively coupled to position sensors 234. Controller 132 is configured to execute operations to control AMB system 102 based at least partially on position signals, generally indicated by signal path 134, transmitted to controller 132 by position sensors 132, and on instructions from human operators. In the exemplary embodiment, position signals 134 are representative of an air gap 312, 412 (shown in FIGS. 3 and 4, respectively) distance between impellers 202, 204, and a respective one of actuators 220. Operations executed by controller 132 may include, for example, and without limitation: (a) sensing operating parameters of actuators 220, 226; (b) performing remote monitoring and diagnostics of pump 100 based on current control signals 136 applied to actuators 220, 226; (c) collecting real-time data on the current control signals 136 and the position signals 134 of the actuators 220, 226 to facilitate predicting future failures and/or to schedule maintenance of pump 100; (d) detecting faults in actuators 220, 226; (e) applying fault tolerant control of actuators 220, 226 if non-critical faults are detected in pump 100 to facilitate avoiding shutting down pump 100 while facilitating operating pump 100 in a safe manner, therefore, facilitating increasing availability of pump 100; and (f) applying normal operation control algorithms to control operation of AMB system 102, such as by regulating an amount of magnetic force generated by actuators 220, 226. Commands generated by controller 132 cause actuators 220, 226 to adjust the air gap 312, 412 between impellers 202, 204 and actuators 220, 226 to a desired amount.

In addition, controller 132 is coupled to one or more power amplifiers 512 (not shown in FIGS. 1 and 2), which are coupled to actuators 220, 226, respectively, for transmitting current control signals 136 that are applied to actuators 220, 226. In the exemplary embodiment, position sensors 234 are configured to transmit position signals 134 that generally include an electrical voltage indicative of the position of impellers 202, 204 to controller 132. Normally, position sensors 234 are calibrated so that when impellers 202, 204 are at a desired location, position sensors 234 produce a null voltage. Thus, when impellers 202, 204 are moved from the desired position, a voltage indicative of the new position is generated.

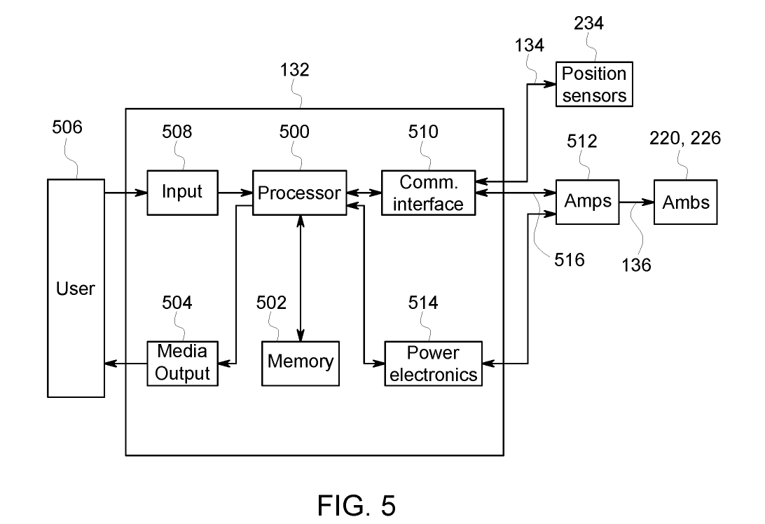

FIG. 5 is a block diagram of controller 132 for use with AMB system 102 (shown in FIG. 1). In the exemplary embodiment, controller 132 is enclosed in controller section 106 (shown in FIG. 1) of pump 100 (shown in FIG. 1). Controller 132 includes a processor 500 for executing instructions. In some implementations, executable instructions are stored in a memory area 502. Processor 500 may include one or more processing units (e.g., in a multi-core configuration). Memory area 502 is any device allowing information such as executable instructions and/or other data to be stored and retrieved. Memory area 502 stores parameters for controlling the operation of AMB system 102, as described in more detail herein. Memory area 502 includes one or more computer-readable media.

In the exemplary embodiment, controller 132 includes at least one media output component 504 for presenting information to a user 506. Media output component 504 is any component capable of conveying information to user 506. In some implementations, media output component 504 includes an output adapter such as a video adapter and/or an audio adapter. An output adapter is operatively coupled to processor 500 and operatively couplable to an output device such as a display device (e.g., a liquid crystal display (LCD), one or more light emitting diodes (LED), an organic light emitting diode (OLED) display, cathode ray tube (CRT), or “electronic ink” display) or an audio output device (e.g., a speaker or headphones). In other embodiments, controller 132 does not include media output component 504.

Controller 132 includes an input device 508 for receiving input from user 506. Input device 508 may include, for example, without limitation, one or more buttons, a keypad, a touch sensitive panel (e.g., a touch pad or a touch screen), and/or a microphone. A single component such as a touch screen may function as both an output device of media output component 504 and input device 508. Some embodiments of controller 132 do not include input device 508.

In the exemplary embodiment, controller 132 includes a communication interface 510, which is communicatively couplable to other devices, for example power amplifiers 512 and position sensors 234. In some embodiments, communication interface 510 is configured to enable communication through a short range wireless communication protocol such as Bluetooth™or Z-Wave™, through a wireless local area network (WLAN) implemented pursuant to an IEEE (Institute of Electrical and Electronics Engineers) 802.11 standard (i.e., WiFi), and/or through a mobile phone (i.e., cellular) network (e.g., Global System for Mobile communications (GSM), 3G, 4G) or other mobile data network (e.g., Worldwide Interoperability for Microwave Access (WIMAX)), or a wired connection (i.e., one or more conductors for transmitting electrical signals). In embodiments that communication interface 510 couples controller 132 to position sensors 234, communication interface 510 may include, for example, one or more conductors for transmitting electrical signals and/or power to and/or from position sensors 234. Additionally, controller 132 may also include power electronics 514, which may be coupled, for example, to processor 500 and power amplifiers 512.

In the exemplary embodiment, controller 132 receives air gap 312, 412 distance values transmitted as position signals 134 from position sensors 234. Such air gap distance values relate to the distance between actuators 220, 226 and impellers 202, 204. Controller 132 compares the air gap distance values to a predetermined value range for air gap distance, which is stored in memory area 502. In addition, controller 132 receives electrical current values transmitted from amplifiers 512 to actuators 220, 226. The controller 132 compares the electrical current values to a predetermined value range for current values at the current operating state of pump 100. In the exemplary embodiment, controller 132 generates control action signals 516 based on the air gap and electrical current comparisons. The control action represents a force necessary to move impellers 202, 204 back to the predetermined air gap distance value range. Upon determining the control action, controller 132 transmits control action signals 516 to amplifiers 512. In the exemplary embodiment, control action signals 516 correspond to ongoing current requirements for actuators 220, 226 and can be adjusted in a liner and a non-linear manner. In this manner, controller 132 can determine the rotor dynamics of each individual pump stage 118, 120. The controller 132 is able to generate control action signals 516 that facilitate counteracting the rotor dynamics to facilitate reducing vibrations and other gyroscopic motions.

In the exemplary embodiment, current control signals 136 pass through power amplifiers 512 to provide an appropriate amount of current to actuators 220, 226, which provide an attractive force to correct the position of impellers 202, 204 along each actuator 220, 226. In some embodiments, power amplifiers 512 are voltage switches that are turned on and off at a high frequency, as commanded by control action signals 516 from controller 132. In such embodiments, control action signals 516 are pulse width modulation (PWM) signals.

In the exemplary embodiment, AMB system 102 operates as a closed-loop system. AMB system 102 has a sample rate in the range between about 2,000 cycles per second to about 100,000 cycles per second, which may also be referred to as having a sample rate frequency in the range between about 2 kilohertz (kHz) and 100 kHz.

As described herein, magnetic suspension of impellers 202, 204 using AMB system 102 is a complete magnetic suspension, facilitating controlling impellers 202, 204 movements in five degrees of freedom (the sixth degree of freedom being axial rotation). Auxiliary bearings 236 provide support only in case of overload or malfunction of AMB system 102. Partial magnetic suspension, i.e., a hybrid solution, facilitates controlling impellers 202, 204 movements in fewer than five degrees of freedom. The degrees of freedom not controlled by AMBs are restricted by conventional bearings, thus leading to a hybrid solution.

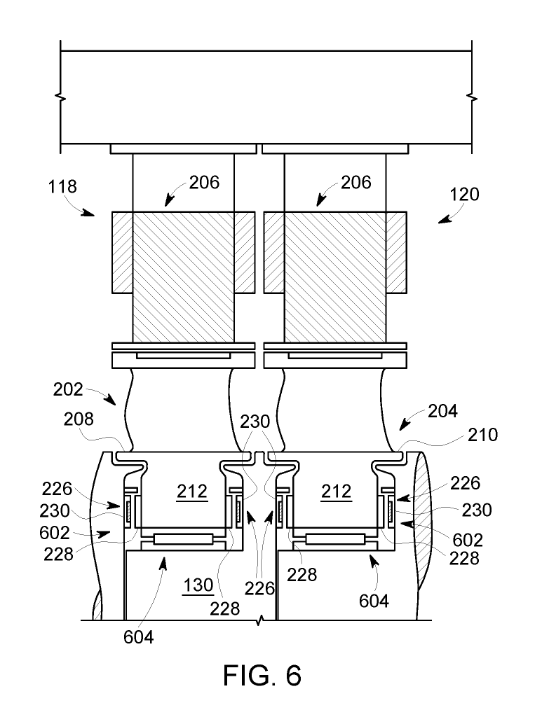

FIG. 6 is an enlargement of a portion of pump 100 (shown in FIG. 1), illustrating an alternative AMB system 602. In the exemplary alternative embodiment, AMB system 602 only includes actuators 226 coupled between each of impellers 202, 204, and stationary shaft 130. Alternatively, AMB system 602 can include any number of axial actuators that enable impellers 202, 204 to function as described herein. As described herein, each actuator 226 includes two non-laminated rotor rings 228 coupled to opposite ends of impellers 202, 204. In particular, rotor rings 228 are coupled to root 212 of respective impeller blades 208 and 210. Actuator 226 also includes two stators 230 coupled to stationary shaft 130. However, control of impellers 202, 204 in the radial direction is accomplished using conventional roller bearings 604. Roller bearings 604 include, for example, and without limitation, polycrystalline diamond radial bearings.

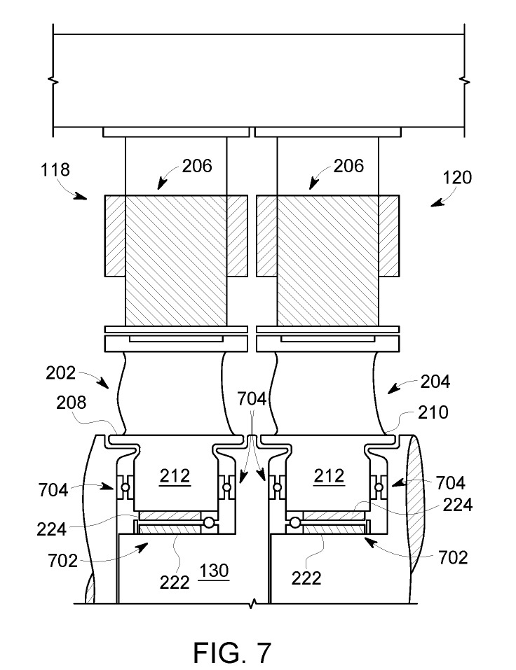

FIG. 7 is an enlargement of a portion of pump 100 (shown in FIG. 1), illustrating another alternative AMB system 702. In the exemplary alternative embodiment, AMB system 702 only includes actuators 220 coupled between each of impellers 202, 204, and stationary shaft 130. Alternatively, AMB system 702 can include any number of radial actuators that enable impellers 202, 204 to function as described herein. As described herein, each actuator 220 includes an inner stator 222 coupled to stationary shaft 130. Actuator 220 also includes an outer rotor 224 lamination stack coupled to an inner diameter of impellers 202, 204. However, control of impellers 202, 204 in the axial direction is accomplished using conventional mechanical thrust bearings 704. Thrust bearings 704 include, for example, and without limitation, polycrystalline diamond thrust bearings.

The embodiments described herein enable control of each individual AMB independently, according to the current properties of the multiphase fluid, for example, flow gas/volume fraction and volumetric flow. Individual control the AMBs facilitates controlling stiffness and damping characteristics for each stage of the axial modular MCP in a linear or non-linear manner. In addition, the operating parameters of the AMBs are known and/or are sensed by the controller, thereby facilitating performing remote monitoring and diagnostics of the MCP based on current control signals applied to actuators and the position sensor measurements. Furthermore, collecting real-time data on the current control signals and the position sensor measurements facilitate predicting future failures and/or scheduling maintenance of the MCP. In contrast to known MCPs used in subsea operations, the AMB system described herein facilitates reducing friction losses, facilitating higher operating speeds of the MCP. In addition, the AMB system does not require lubrication, thereby enabling elimination of an auxiliary bearing lubrication system, which facilitates reducing the manufacturing cost of the MCP.

An exemplary technical effect of the methods, systems, and apparatus described herein includes at least one of: (a) performing remote monitoring and diagnostics of the MCP based on current control signals and position sensor signals; (b) predicting future failures and maintenance needs of the MCP; (c) detecting faults in the AMB system; and (d) applying fault tolerant control of the AMB system to facilitate avoiding shutting down the MCP system.

Exemplary embodiments of AMB systems for a subsea axial modular contra-rotating pump are described above in detail. The systems and methods described herein are not limited to the specific embodiments described, but rather, components of systems and/or steps of the methods may be utilized independently and separately from other components and/or steps described herein. For example, the methods may also be used in combination with other magnetic bearing systems and detection methods, and are not limited to practice with only the systems and methods, as is described herein. Rather, the exemplary embodiments can be implemented and utilized in connection with many rotor-dynamic machine system applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An active magnetic bearing system comprising:
a radial actuator comprising a radial stator coupled to a stationary component, and a radial rotor coupled to a rotatable impeller, said radial rotor extending circumferentially with respect to said radial stator and configured to rotate thereabout; and
an axial actuator comprising a first rotor ring, a second rotor ring, a first stator, and a second stator, said first rotor ring coupled to a first axial end of the rotatable impeller, said second rotor ring coupled to a second axial end of the rotatable impeller opposite the first axial end, said first stator coupled to the stationary component adjacent said first rotor ring in a face-to-face orientation, and said second stator coupled to the stationary component adjacent said second rotor ring in a face-to-face orientation, wherein said radial actuator is positioned axially between said first rotor ring and said second rotor ring.

2. An active magnetic bearing system in accordance with claim 1, wherein said radial actuator is a fault tolerant actuator, said radial stator comprising at least six adjacent electromagnets configured such that each electromagnet is positioned opposite a corresponding electromagnet.

3. An active magnetic bearing system in accordance with claim 2, wherein said radial stator further comprises a plurality of nonmagnetic flux barriers, a respective nonmagnetic flux barrier of said plurality of nonmagnetic flux barriers positioned between respective said adjacent electromagnets.

4. An active magnetic bearing system in accordance with claim 1 further comprising a first position sensor coupled adjacent said radial actuator, and a second position sensor coupled adjacent said axial actuator.

5. An active magnetic bearing system in accordance with claim 1, wherein at least one of said first stator and said second stator comprises an axisymmetric C-shaped core.

6. An active magnetic bearing system in accordance with claim 1, wherein at least one of said first stator and said second stator comprises an axisymmetric E-shaped core.

7. A turbomachine comprising:
a casing;
a stationary shaft having a longitudinal center axis;
a first pump stage positioned in said casing, said first pump stage comprising a first rotatable impeller configured to rotate about the longitudinal center axis and comprising a first blade comprising a first root;
a second pump stage positioned in said casing, said second pump stage comprising a second rotatable impeller configured to rotate about the longitudinal center axis and comprising a second blade comprising a second root; and
an active magnetic bearing system comprising an axial actuator comprising a first rotor ring, a second rotor ring, a first stator, and a second stator, said first rotor ring coupled to a first end of at least one of said first root and said second root, said second rotor ring coupled to a second end of said at least one of said first root and said second root opposite said first end, said first stator coupled to said stationary shaft adjacent said first rotor ring in a face-to-face orientation, and said second stator coupled to said stationary shaft adjacent said second rotor ring in a face-to-face orientation, wherein said first rotatable impeller is configured to rotate independently of said second rotatable impeller.

8. A turbomachine in accordance with claim 7, wherein said active magnetic bearing system further comprises a radial actuator comprising an outer rotor coupled to at least one of said first root and said second root, said radial actuator further comprising an inner stator coupled to said stationary shaft.

9. A turbomachine in accordance with claim 8, wherein said radial actuator comprises at least one electromagnet and at least one permanent magnet.

10. A turbomachine in accordance with claim 8, wherein said radial actuator is a fault tolerant actuator comprising at least six adjacent electromagnets configured such that each electromagnet is positioned opposite a corresponding electromagnet.

11. A turbomachine in accordance with claim 10, wherein said inner stator comprises a plurality of nonmagnetic flux barriers, a respective nonmagnetic flux barrier of said plurality of nonmagnetic flux barriers positioned between respective said adjacent electromagnets.

12. A turbomachine in accordance with claim 7, wherein said first rotatable impeller is configured to rotate in a first direction, and wherein said second rotatable impeller is configured to rotate in a second direction opposite said first direction.

13. A turbomachine in accordance with claim 7 further comprising a radial auxiliary bearing positioned between said stationary shaft and at least one of said first rotatable impeller and said second rotatable impeller.

14. A turbomachine in accordance with claim 13, wherein said radial auxiliary bearing comprises one or more of the following: a ball bearing, a roller bearing, and a journal bearing.

15. A turbomachine in accordance with claim 7, further comprising a controller configured to actuate said axial actuator to generate a magnetic flux in said actuator.

16. A method of assembling a multistage turbomachine, said method comprising:
coupling a stationary shaft within a casing, the stationary shaft having a longitudinal center axis;
rotatably coupling a first impeller to the stationary shaft, the first impeller configured to rotate about the longitudinal center axis, the first rotatable impeller including a first blade having a first root;
rotatably coupling a second impeller to the stationary shaft adjacent the first impeller, the second impeller configured to rotate about the longitudinal center axis, the second impeller including a second blade having a second root; and
coupling an axial actuator to at least one of the first impeller and the second impeller, the axial actuator including a first rotor ring, a second rotor ring, a first stator, and a second stator, wherein coupling the axial actuator comprises:
coupling the first rotor ring to a first end of at least one of the first root and the second root;
coupling the second rotor ring to a second end opposite the first end of the at least one of the first root and the second root;
coupling the first stator to the stationary shaft adjacent the first rotor ring in a face-to-face orientation; and
coupling the second stator to the stationary shaft adjacent the second rotor ring in a face-to-face orientation, wherein the first rotatable impeller is configured to rotate independently of the second rotatable impeller.

17. A method in accordance with claim 16 further comprising coupling a radial actuator to at least one of the first impeller and the second impeller, the radial actuator including an outer rotor coupled to a root of the at least one of the first impeller and the second impeller.

18. A method in accordance with claim 17, wherein the radial actuator includes an inner stator, and wherein coupling a radial actuator to at least one of the first impeller and the second impeller includes coupling the inner stator to the stationary shaft.

19. A method in accordance with claim 16 further comprising positioning a radial auxiliary bearing between the stationary shaft and at least one of the first impeller and the second impeller.

20. A method in accordance with claim 16, wherein the first rotatable impeller is configured to rotate in a first direction, and wherein the second rotatable impeller is configured to rotate in a second direction opposite the first direction.
